(19) United States
(12) Patent Application Publication
(10) Pub. No.: US 2007/0262215 A1
(43) Pub. Date: Nov. 15, 2007

(54) Flat panel mount

(76) Inventor: Seng-Ling Tan, Singapore (SG)

Correspondence Address: COOPER & DUNHAM, LLP, 1185 AVENUE OF THE AMERICAS, NEW YORK, NY, 10036, US

(21) Appl. No.: 11/475,379

(22) Filed: Jun. 27, 2006

(30) Foreign Application Priority Data
May 12, 2006 (TW) 095208100

(51) Int. Cl. F16M 11/00

(52) U.S. Cl. 248/201; 248/923

(57) ABSTRACT

A flat panel mount for a plasma television having a back and a wall plate has an inner bracket, an outer bracket and a positioning assembly. The outer bracket covers the inner bracket inside and is pivotally mounted to the inner bracket. The positioning assembly is mounted between and abuts with the inner bracket and the outer bracket. Two outer brackets are mounted to the back of the plasma television and the inner brackets are mounted to the wall plate so that the plasma television is hung on a wall with two mounts with such an arrangement, to adjust the display angle of a plasma television is convenient.

### BACKGROUND OF THE INVENTION

1. Field of the Invention

The present invention relates to a mount, and more particularity to a flat panel mount that is able to hang a flat panel television to a certain location and easy to adjust a view angel of the flat panel television.

2. Description of Related Art

A flat panel television has benefits of weight-lighting, thin and display excellent. A plasma television is a best representation of the flat panel television. Because most of the plasma televisions are for commercial using so that mounts are necessary for installing the plasma televisions at certain locations.

A conventional mount in accordance with the prior art for a plasma television having a back with a left side and a right side and a wall plate mounted to a wall and having a bottom edge and a top edge has two embodiments. A first embodiment of the conventional mount is a single bolt-pushing tightened mount. A second embodiment is a dual bolts-pushing tightened mount.

With reference to FIG. 7, a conventional single bolt-pushing tightened mount has an inner bracket (70), an outer bracket (70), a blot (78) and a nut (79).

The inner bracket (70) has an inner face, a top hook (71), a bottom hook (72), two sides and two inner wings (73). The inner face of the inner bracket (70) has a top end and a bottom end. The top hook (71) is formed on the top end of the inner face of the inner bracket (70). The bottom hook (72) is formed on the bottom end of the inner face of the inner bracket (70). The inner wings (73) are separately formed on the sides of the inner bracket (70) and each has a hole (74). The hole (74) is formed through the inner wing (73) and corresponds to each other.

The outer bracket (75) has two sides and two outer wings (76). The outer wings (76) are separately formed on the sides of the outer bracket (75) and each has a curved hole (77). The curved hole (77) is formed through the outer wing (76) and corresponds to each other.

The blot (78) extends through the curved holes (77) of the outer bracket (75) and the holes (74) of the inner bracket (70) and is screwed with the nut (79) to combine the outer bracket (75) and the inner bracket (70) together.

With reference to FIG. 8, the conventional dual bolts-pushing tightened mount has an inner backer (80), an outer bracket (90), two blots (86, 94), a nuts (95), a washer (87) and a knob (88).

The inner bracket (80) has an inner face, a top hook (81), a bottom hook (82), two sides and two inner wings (83). The inner face of the inner bracket (80) has a top end and a bottom end. The top hook (81) is formed on the top end of the inner face of the inner bracket (80). The bottom hook (82) is formed on the bottom end of the inner face of the inner bracket (80). The inner wings (83) are separately formed on the sides of the inner bracket (80) and each has an inner curved hole (85) and a hole (84). The inner curved hole (85) is formed through the inner wing (83) and corresponds to each other. The hole (84) is formed through the inner wing (83), corresponds to each other and is adjacent to the inner long hole (84) of the inner wing (83).

The outer bracket (90) has two sides and two outer wings (91). The outer wings (91) are separately formed on the sides of the outer bracket (90) and each has a hole (92) and a securing hole (93). The hole (92) is formed through the outer wing (90) and corresponds to each other. The securing hole (93) is formed through the outer wing (90), corresponds to each other and is adjacent to the hole (92) of the outer wing (90).

The blot (86) extends through the securing holes (93) of the outer bracket (90) and the inner long holes (85) of the inner bracket (80) and is screwed with the knob (88).

The blot (94) extends through the station holes (92) of the outer bracket (90) and the holes (84) of the inner bracket (80) and is screwed with the nub (95) so that the inner bracket (80) and the outer bracket (90) is combined together.

Two outer brackets (75, 90) are separately mounted on the right side and left side of the back of the plasma television. The top hooks (71, 81) and the bottom hooks (72, 82) of the inner brackets (70, 80) are separately engaged with the top edge and the bottom edge of the wall plate so that the plasma television is hung at a desired location.

To adjust a display angle of the plasma television with the conventional bolt-pushing tightened mount, the bolt (78) is loosened so that the outer bracket (75) is pivoted relative to the inner bracket (70). After the bracket (75) is rotated to a desired angle, the bolt (78) is turned in reverse to tightly screwed with the nut (79) so that the plasma television is stayed at a desired display angle.

To adjust the display angle of the plasma television with the conventional dual bolts-pushing tightened mount, the knob (88) is turned to release the bolt (86) from the knob (88). The outer bracket (90) is then pivoted relative to the inner bracket (80) so that the display angle of the plasma television is adjusted. After the adjustment is completed, the knob (88) is turned in reverse to screw the knob (88) with bolt (86) tightly again, and the plasma television is held at the desired display angle.

However, at least two persons are necessary for the adjustment process of the conventional mount. One is holding the plasma television and adjusts the display angle of the plasma television. Another person is unscrewing and screwing the bolt (76) or the knob (88) and the bolt (86). Therefore, the operation and use of the convention mount is very inconvenient.

To overcome the shortcomings, the present invention provides a flat panel mount to obviate or mitigate the aforementioned problems.

### SUMMARY OF THE INVENTION

The primary objective of the present invention is to provide a flat panel mount that is easy to adjust a display angle of a plasma television.

The flat panel mount for a plasma television having a back and a wall plate has an inner bracket, an outer bracket and a positioning assembly. The outer bracket covers the inner bracket inside and is pivotally mounted to the inner bracket. The positioning assembly is mounted between and abuts with the inner bracket and the outer bracket. Two outer brackets are mounted to the back of the plasma television and the inner brackets are mounted to the wall plate to hang the plasma television on the wall with two mounts.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a flat panel mount in accordance with the present invention;

FIG. 2 is a side plan view in partial section of the flat panel mount in FIG. 1

FIG. 3 is a perspective view of the flat panel mount mounted with a wall plate;

FIG. 4 is an operational side view of the flat panel mount when a display angle of a plasma television is adjusted with the flat panel mount;

FIG. 5 is an exploded perspective view of a second embodiment of a flat panel mount in accordance with the present invention;

FIG. 6 is an exploded perspective view of a third embodiment of a flat panel mount in accordance with the present invention;

FIG. 7 is an exploded perspective view of a first embodiment of a conventional mount in accordance with the prior art; and

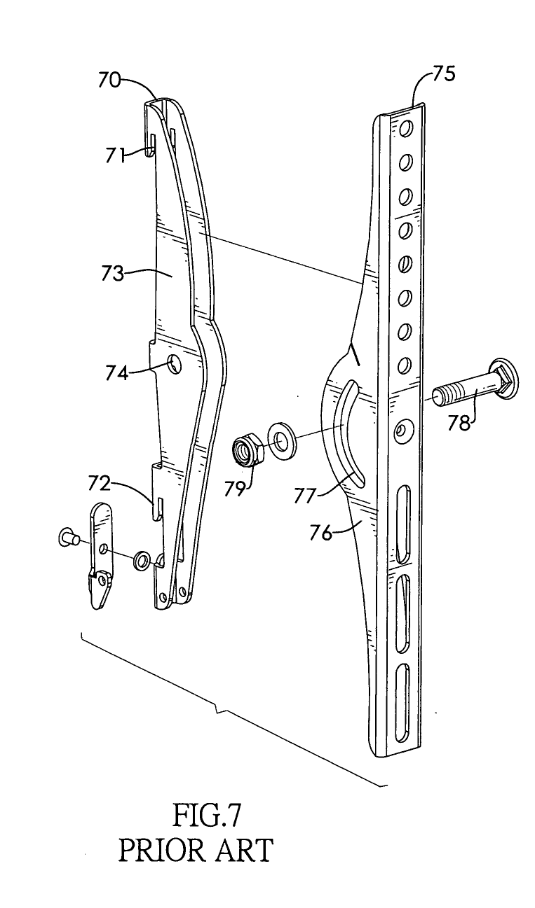

FIG. 8 is an exploded perspective view of a second embodiment of a conventional mount in accordance with the prior art.

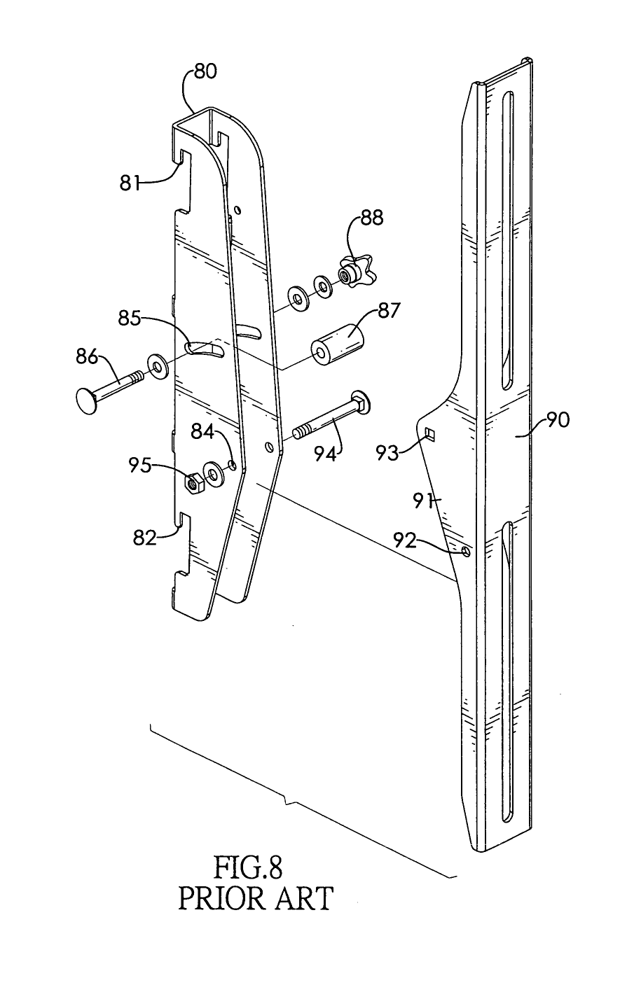

### DETAILED DESCRIPTION OF THE PREFERRED EMBODIMENT

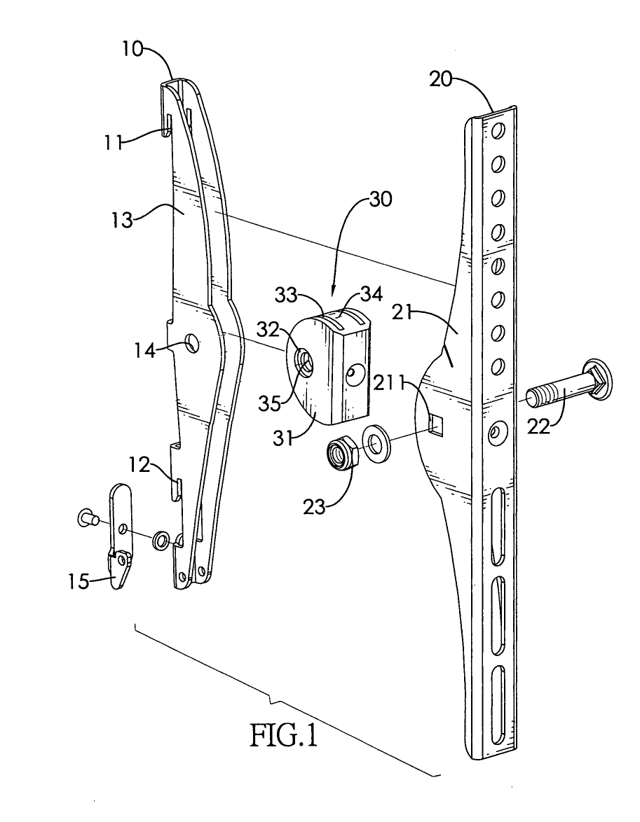

With reference to FIGS. 1, 3, 5 and 6, a flat panel mount in accordance with the present invention for a plasma television has an inner bracket (10), an outer bracket (20), a positioning assembly (30, 50, 60), an optional bolt (22) and an optional nut (23). The plasma television has a back with a left side and a right side and a wall plate (40) mounted to a wall and having a bottom edge and a top edge.

The inner bracket (10) has an inner face, a top hook (11), a bottom hook (12), two sides, an optional locking bracket (15) and two inner wings (13). The inner face of the inner bracket (10) has a top end and a bottom end. The top hook (11) is formed on the top end of the inner face of the inner bracket (10). The bottom hook (12) is formed on the bottom end of the inner face of the inner bracket (10). The locking bracket (15) is pivotally mounted on the bottom end of the inner face of the inner bracket (10) and near the bottom hook (12) of the inner bracket (10). The inner wings (13) are separately formed on the sides of the inner bracket (10) and each has a hole (14), an inner face and an outer face. The hole (14) is formed through the inner wing (13) and corresponds to each other.

The outer bracket (20) covers the inner bracket (10) inside and has two sides and two outer wings (21). The outer wings (21) are separately formed on the sides of the outer bracket (20) and each has a hole (211) and an inner face. The hole (211) is formed through the outer wing (21) and corresponds to each other.

The positioning assembly (30, 50, 60) is mounted between the inner wings (13) of the inner bracket (10) and the outer wings (21) of the outer bracket (20).

In a first embodiment of the flat panel mount in accordance with the present invention, the positioning assembly (30) may have a block (34), two clamping wings (31) and two slots (33).

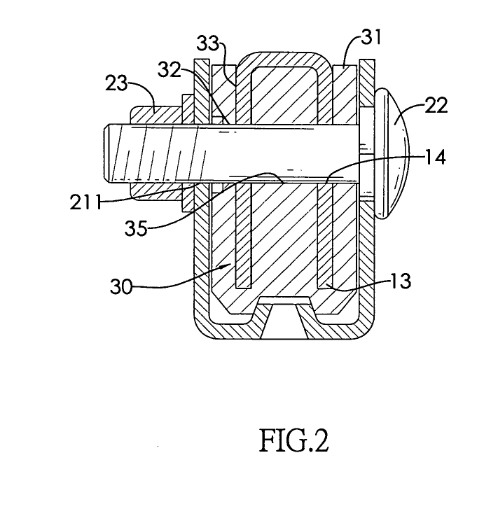

With further reference to FIG. 2, the block (34) is mounted between two inner wings (13) of the inner bracket (10) and has a through hole (35), two faces and two edges. The through hole (35) is formed through the block (34). Each face of the block (34) corresponds to and abuts against the inner face of one of the two inner wings (13) of the inner bracket (10).

The two clamping wings (31) are separately connected to the two edges of the block (34). Each clamping wing (31) is located between one of the inner wings (13) of the inner bracket (10) and a corresponding one of the outer wings (21) of outer bracket (20) and has an inner face, an outer face and a hole (32). The inner face of the clamping wing (31) abuts against the outer face of the corresponding inner wing (13) of the inner bracket (10). The outer face of the clamping wing (31) abuts against the inner face of the outer wing (21) of the outer bracket (20). The hole (32) is formed through the clamping wing (31) and corresponds to and aligns with the through hole (35) of the block (34).

The two slots (33) are separately formed between the two clamping wings (31) and the block (34) and hold the inner wings (13) of the inner bracket (10) inside.

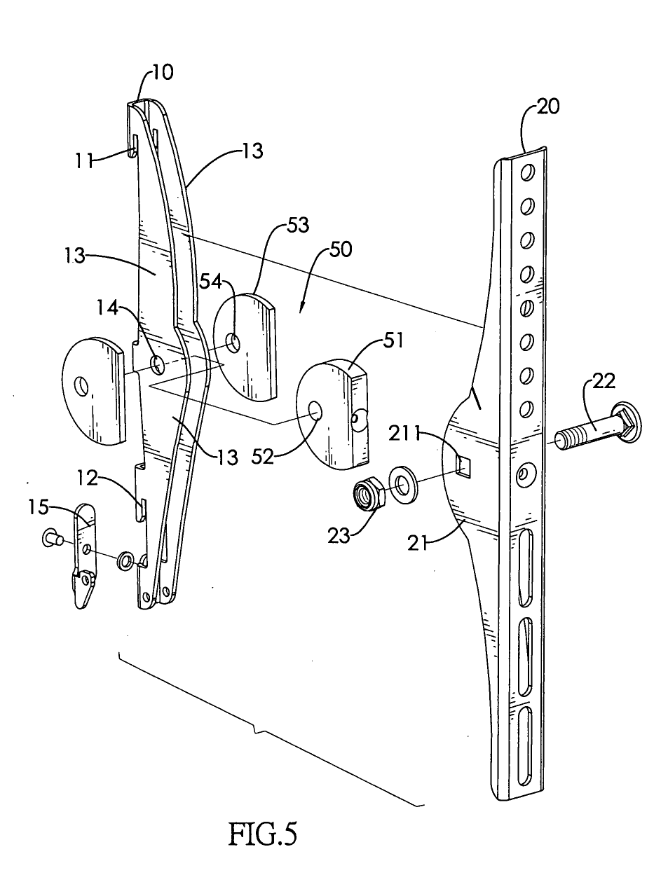

In a second embodiment, with reference to FIG. 5, the positioning assembly (50) may have an inner block (51) and two outer blocks (53).

The inner block (51) is mounted between the two inner wings (13) of the inner bracket (10) and has two side faces and a through hole (52). Each side face of the inner block (51) abuts against the inner face of one of the inner wings (13) of the inner bracket (10). The through hole (52) is formed through the inner block (51).

Each outer block (53) is mounted between one of the inner wings (13) of the inner bracket (10) and a corresponding one of the outer wings (21) of the outer bracket (20) and has an inner face, an outer face and a hole (54). The inner face of the outer block (53) abuts against the outer face of corresponding inner wing (13) of inner bracket (10). The outer face of the outer block (53) abuts against the inner faces of the corresponding outer wing (21) of the outer bracket (20). The hole (54) is formed through the outer block (53) and corresponds to and aligns with the through hole (52) in the inner block (51).

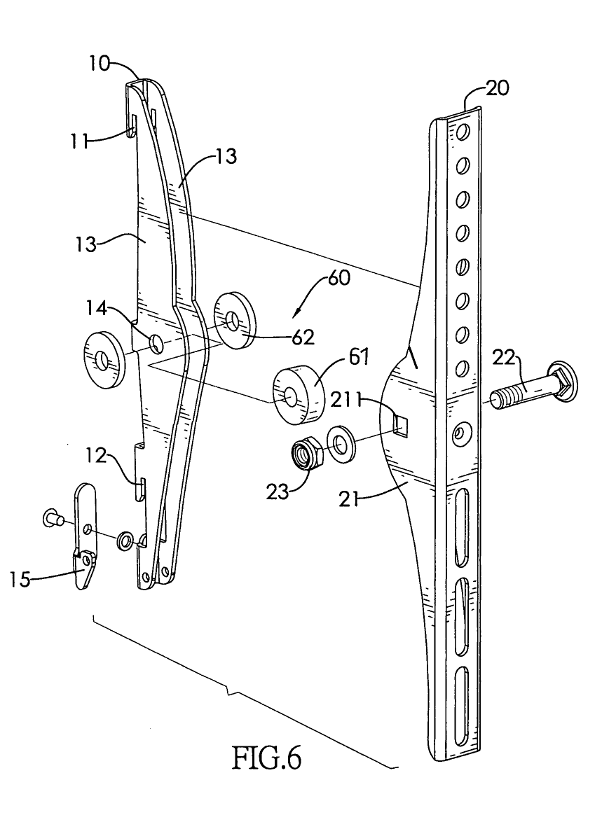

In a third embodiment, with reference to FIG. 6, the positioning assembly (60) may have an inner washer (61) and two outer washers (62).

The inner washer (61) is mounted between the two inner wings (13) of the inner bracket (10) and has two side faces and a through hole. Each side face of the inner washer (61) abuts against the inner face of one of the inner wings (13) of the inner bracket (10). The through hole is formed through the inner washer (61).

Each outer washer (62) is mounted between one of the inner wings (13) of the inner bracket (10) and a corresponding one of the outer wings (21) of the outer bracket (20) and has an inner face, an outer face and a hole. The inner face of the outer washer (62) abuts against the outer face of the corresponding inner wing (13) of inner bracket (10). The outer face of the outer washer (62) abuts against the inner face of the corresponding outer wing (21) of the outer bracket (20). The hole is formed through the outer washer (62) and corresponds to and aligns with the through hole in the inner washer (61).

The blot (22) extends through the holes (211) of the outer bracket (20), the through hole (35,52) and holes (32, 54) in the positioning assembly (30, 50, 60) and the holes (14) of the inner bracket (10) and is screwed with the nut (23) to pivotally combine the outer bracket (20) and the inner bracket (10) together.

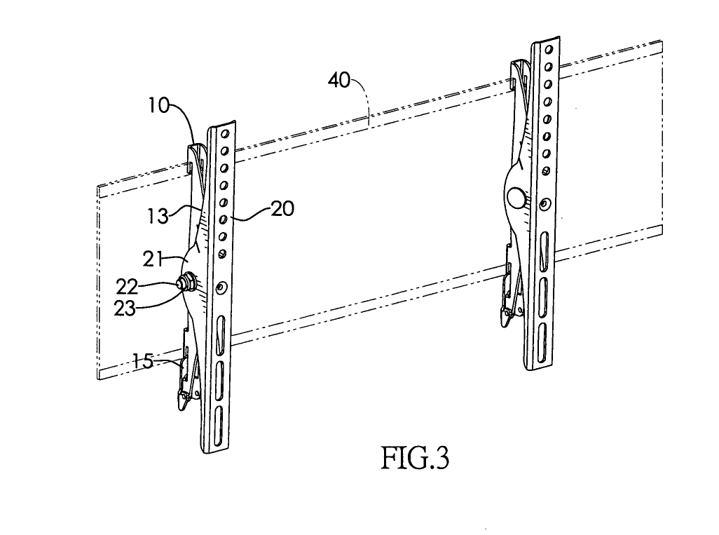

In use, two mounts are connected to a plasma television with two outer brackets (20) being separately mounted on the left end and right sides of the back of the plasma television. With reference to FIG. 3, the top hook (11) and the bottom hook (12) of each inner bracket (10) separately engage with the top edge and the bottom edge of the wall plate (40) so that the plasma television is hung on a wall with the mounts. The locking bracket (15) allows the plasma television to be locked in cooperation with a locking device to keep the plasma television from being unauthorizedly moved.

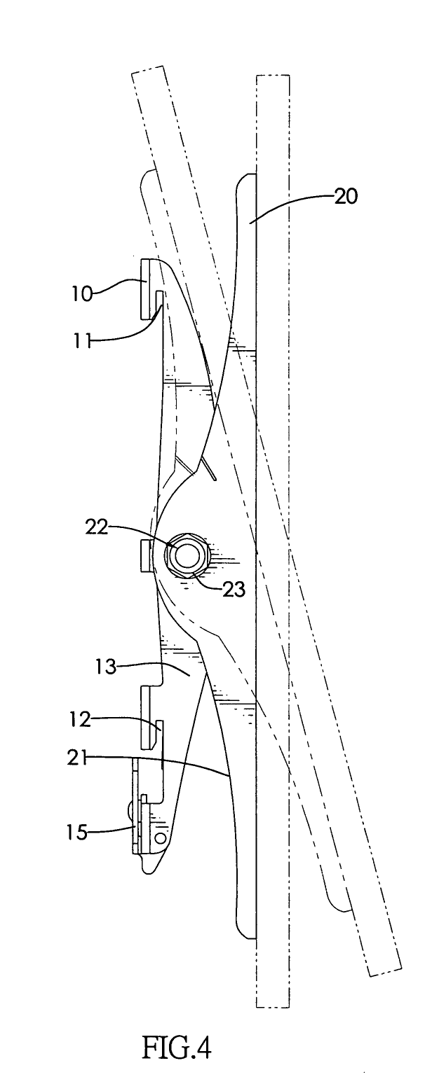

With further reference to FIG. 4, when the plasma television is adjusted in a display angle, the plasma television is pulled toward or pushed away from the wall plate (40) to pivotally rotate the outer brackets (20) relative to the inner brackets (10). When the television is pivoted to a desired angle, the friction between the outer bracket (20), the positioning assembly (30, 50, 60) and the inner bracket (10) is able to hold the plasma television to at the desired angle in stable.

Consequently, because the adjustment of display degree of a television is by means of to pulling or pushing the television directly, so only one person is needed for the adjusting the display angle of the television and the adjustment process of the display angle is convenient.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended

I claims are expressed.

What is claimed is:

1. A flat panel mount comprising
an inner bracket having
an inner face having
a top end; and
a bottom end;
a top hook formed on the top end of the inner face of the inner bracket;
a bottom hook formed on the bottom end of the inner face of the inner bracket;
two sides; and
two inner wings separately formed on the sides of the inner bracket and each having
an inner face; and
an outer face;
an outer bracket covering the inner bracket inside, pivotally mounted to the inner bracket and having
two sides; and
two outer wings separately formed on the sides of the outer bracket and each having an inner face; and
a positioning assembly mounted between the inner wings of the inner bracket and the outer wings of the outer bracket and abutting against the inner faces and the outer faces of the inner wings of the inner bracket and the inner faces of the outer wings of the outer bracket.

2. The flat panel mount as claimed in claim 1, wherein
the positioning assembly comprises
a block being mounted between the inner wings of the inner bracket and having
a through hole formed through the block;
two faces respectively corresponding to and abutting against the inner faces of the two inner wings of the inner bracket; and
two edges;
two clamping wings separately connected to the two edges of the block, and each clamping wing being mounted between a corresponding one of the inner wings of the inner bracket and a corresponding one of the outer wings of outer bracket and having
an inner face abutting against the outer face of the corresponding inner wing of the inner bracket;
an outer face abutting against the inner face of the corresponding outer wing of the outer bracket; and
a hole formed through the clamping wing and corresponding to and aligning with the through hole of the block;
two slots separately formed between the two clamping wings and the block to respectively hold the inner wings of the inner bracket inside;
the inner bracket further has
two holes respectively formed through the inner wings of the inner bracket;
the outer bracket further has
two holes respectively formed through the outer wings of the outer bracket; and
the flat panel further has
a bolt extending the holes in the outer bracket, the holes in the clamping wings of the positioning assembly, the holes in the inner bracket and the through hole in the block of the positioning assembly; and
a nut screwed with the bolt.

3. The flat panel mount as claimed in claim 1, wherein
the positioning assembly comprises
an inner block mounted between the two inner wings of the inner bracket and having
two side faces abutting respectively against the inner faces of the inner wings of the inner bracket; and
a through hole formed through the inner block;
two outer blocks each mounted between a corresponding one of the inner wings of the inner bracket and a corresponding one of the outer wings of the outer bracket and having
an inner face abutting against the outer face of the corresponding inner wings of inner bracket;
an outer face abutting against the inner face of the corresponding outer wing of the outer bracket; and
a hole formed through the outer block;
the inner bracket further has
two holes formed respectively through the inner wings of the inner bracket;
the outer bracket further has
two holes formed respectively through the inner wings of the outer bracket; and
the flat panel further has
a bolt extending the holes of the outer bracket, the holes of the outer blocks of the positioning assembly, the holes of the inner bracket and the through hole of the inner block of the positioning assembly; and
a nut screwed with the bolt.

4. The flat panel mount as claimed in claim 1, wherein
the positioning assembly comprises
an inner washer mounted between the two inner wings of the inner bracket and having
two side face abutting respectively against the inner faces of the inner wings of the inner bracket; and
a through hole formed through the inner washer;
two outer washers each mounted between a corresponding one of the inner wings of the inner bracket and a corresponding one of the outer wings of the outer bracket and having
an inner face abutting against the outer face of the corresponding inner wing of inner bracket;
an outer face abutting against the inner face of the corresponding outer wing of the outer bracket; and
a hole formed through the outer washer;
the inner bracket further has
two holes formed respectively through the inner wings of the inner bracket;
the outer bracket further has
two holes formed respectively through the outer wings of the outer bracket; and
the flat panel further has
a bolt extending the holes of the outer bracket, the holes of the outer washers of the positioning assembly, the holes of the inner bracket and the through hole of the inner washer of the positioning assembly; and
a nut screwed with the bolt.

5. The flat penal mount as claimed in claim 1, wherein the inner bracket further has a locking bracket pivotally mounted on the bottom end of the inner face of the inner bracket and near the bottom hook of the inner bracket.

6. The flat penal mount as claimed in claim 2, wherein the inner bracket further has a locking bracket pivotally mounted on the bottom end of the inner face of the inner bracket and near the bottom hook of the inner bracket.

7. The flat penal mount as claimed in claim 3, wherein the inner bracket further has a locking bracket pivotally mounted on the bottom end of the inner face of the inner bracket and near the bottom hook of the inner bracket.

8. The flat penal mount as claimed in claim 4, wherein the inner bracket further has a locking bracket pivotally mounted on the bottom end of the inner face of the inner bracket and near the bottom hook of the inner bracket.
